(19) United States
(12) Patent Application Publication
(10) Pub. No.: US 2019/0138778 A1
(43) Pub. Date: May 9, 2019

(54) A SYSTEM FOR PRODUCT AUTHENTICATION AND METHOD THEREOF

(71) Applicant: BILCARE LIMITED, Pune (IN)

(72) Inventors: Rajan Pandurang LOHAR, Pune (IN); Prashant Sitaram RANE, Pune (IN); Rahul Gopikisan BHARADIA, Pune (IN); Subodh Yeshawant PANDE, Pune (IN)

(21) Appl. No.: 16/083,873

(22) PCT Filed: Mar. 11, 2017
(86) PCT No.: PCT/IB2017/051430

§ 371 Date: Sep. 10, 2018

(30) Foreign Application Priority Data
Mar. 11, 2016 (IN) 201621008651

(51) Int. Cl. G06K 7/14; G06Q 30/00

(52) U.S. Cl. CPC G06K 7/1417; G06Q 30/0185; G06K 7/1413

(57) ABSTRACT

The present disclosure envisages a system for product authentication comprises a non-replicable security tag, at least one mobile device and a server. The security tag comprises a background print layer and a foreground print layer. The foreground print layer includes a tag identifier and a variable image pattern. The mobile device scans the security tag and 5 facilitates a first level authentication of the tag locally on the mobile device. The server is configured facilitate a second level authentication for the tag over a network.

### FIELD

The present disclosure relates to the field of security tags and product authentication using mobile device.

### DEFINITIONS OF TERMS USED IN THE SPECIFICATION

The expression ‘mobile device’ used hereinafter in the specification refers to, but is not limited to a mobile phone, a laptop, a tablet, a desktop, an iPad, a PDA, a notebook, a net book, a smart device, a smart phone, and the like.

The expression ‘product’ or products used hereinafter in the specification refers to an article or substance such as medical devices, fast moving consumable goods, pharmaceutical products, automobile spares, electronic components, documents, papers and the like.

### BACKGROUND

Counterfeiting of products is a menace and use of counterfeited products such as medicinal and pharmaceutical products can prove to be fatal. Attempts have been made to distinguish genuine products from the counterfeits. Such attempts include using holograms, barcodes, and taggants, and frequent change of pack design. However, there is still a need for an anti-counterfeiting measure which is inexpensive and effective, and which does not require use of custom or proprietary devices for identifying counterfeit products from the genuine products. Additionally, there is a need for an anti-counterfeiting measure which is user friendly and does not require consumers to have high technical skills to identify the counterfeit products.

Apart from counterfeiting, there is also a need in the business for tracking movement of a product from the manufacturing end to its point of sale to end customers or consumers. Further, there is also a need in business for authenticating a genuine product and its attributes to the trader/end customer.

To serve this, the technique envisaged in the present disclosure is manifested in the form of a tag.

### OBJECTS

Some of the objects of the present claimed subject matter aimed to ameliorate one or more problems of the prior art or to at least provide a useful alternative are listed herein below.

An object of the present disclosure is to provide a system for product authentication which ameliorate one or more drawbacks of the prior art.

Another object of the present disclosure is to provide a system for product authentication which is robust, inexpensive and effective.

Yet another object of the present disclosure is to provide a system for product authentication which uses mobile device identifying counterfeit products from genuine products.

Still another object of the present disclosure is to provide a system for product authentication which does not require the consumers to have high technical skills for identifying counterfeits and which is user-friendly.

Further object of the present disclosure is to provide a system for product authentication which can authenticate the product without requiring the internet or network connectivity.

Other objects and advantages of the present disclosure will be more apparent from the following description, which is not intended to limit the scope of the present disclosure.

### SUMMARY

The present disclosure envisages a system for product authentication using at least one mobile device and a server.

At least one non-replicable security tag is affixed to the product. The tag includes a substrate, a background print layer and a foreground print layer. The background print layer is printed on an operative top surface of the substrate. The background print layer is defining background print features. The foreground print layer is printed on the background print layer. The foreground print layer includes at least one tag identifier, at least one variable image pattern, and an encoded security data embedded in the variable image pattern.

Typically, the tag includes a first protective layer and a second protective layer. The first protective layer is disposed on the background print layer and the second protective layer is disposed on the foreground print layer.

Typically, the variable image pattern is generated using the tag identifier as one of the parameters.

Typically, the tag identifier, which is a unique random number, is selected from the group consisting of 2D datamatrix bar code, and QR code.

In accordance with the present disclosure, the mobile device includes a first memory, a first processor, a camera, an image processing module, a decoder, a first verification module, a spatial color gradient determination module, a spatial coefficients determination module, a spatial consistency determination module, a second verification module, a tag verification code determination module, an association computation module, a third verification module, and a first authentication module.

In accordance with the present disclosure, the first memory stores a first set of predetermined rules, and a predefined first security data pattern, a pre-determined consistency factor, and a predetermined association factor. The first processor is cooperating with the first memory. The first processor receives the first set of predetermined rules and further generates a first set of processing commands. The camera, under the first set of processing commands, scans the tag and generates an optical image. The image processing module includes an extractor. The extractor, under the first set of processing commands, processes the optical image and extracts the tag identifier, the variable image pattern and the background print features from the optical image. The decoder, under the first set of processing commands, decodes the encoded security data present in the variable image pattern and obtains decoded security data. The first verification module includes a first comparator. The first comparator, under the first set of processing commands, compares the decoded security data with the predefined first security data pattern, obtains a verified variable image pattern and generates a variable image pattern flag. The spatial color gradient determination module, under the first set of processing commands, determines a spatial color gradient using the background features. The spatial coefficients determination module, under the first set of processing commands, determines spatial coefficients based on the spatial color gradient. The spatial consistency determination module, under the first set of processing commands, determines a consistency factor of the spatial coefficients. The second verification module includes a second comparator. The second comparator, under the first set of processing commands, compares the determined consistency factor with the pre-determined consistency factor and generates a consistency flag. Typically, the consistency flag is either set (true or “logical 1”) or reset (false or “logical 0”) based on the comparison performed by the second comparator. The tag verification code determination module, under the first set of processing commands, determines a tag verification code using the tag identifier and the variable image pattern. The association computation module, under the first set of processing commands, computes an association factor between the verified variable image pattern and the tag verification code. The third verification module includes a third comparator. The third comparator, under the first set of processing commands, compares the computed association factor with the predetermined association factor to obtain an association flag. Typically, the association flag is either set (true or “logical 1”) or reset (false or “logical 0”) based on the comparison performed by the third comparator. The first authentication module, under the first set of processing commands, facilitates a first level authentication of the product when the variable image pattern flag, the consistency flag and the association flag are true.

In accordance with the present disclosure, the server is coupled to the at least one mobile device. Typically the at least one mobile device communicates with the server using wireless communication.

In accordance with the present disclosure, the server includes a second memory, a database, a second processor, a transceiver module, a fourth verification module, a digital signature computation module, a fifth verification module, an optical signature computation module, a fifth verification module, and a second authentication module.

In accordance with the present disclosure, the second memory stores a second set of predetermined rules and a predetermined second security data pattern.

In accordance with the present disclosure, the database stores a pre-determined tag identifier, a pre-determined digital signature, and a pre-determined optical image signature. The second processor communicates with the second memory. The second processor receives the second set of predetermined rules and generates a second set of processing commands. The transceiver module, under the second set of processing commands, receives the optical image, the tag identifier, the decoded security data obtained from the variable image pattern and the background print features. The fourth verification module includes a fourth comparator. The fourth comparator, under the second set of processing commands, compares the tag identifier with the pre-determined tag identifier and obtains a verified tag identifier and generates a first flag. The digital signature computation module, under the second set of processing commands, computes a digital signature from the verified tag identifier and the variable image pattern using the predetermined second security data pattern. The fifth verification module includes a fifth comparator. The fifth comparator, under the second set of processing commands, compares the digital signature with the pre-determined digital signature and generates a second flag. Typically, the second flag is either set (true or “logical 1”) or reset (false or “logical 0”) based on the comparison performed by the fifth comparator. The optical signature computation module, under the second set of processing commands, computes an optical image signature based on the tag identifier, the variable image pattern, the background print features and the optical image. The sixth verification module includes a sixth comparator. The sixth comparator cooperates with the database. The sixth comparator, under the second set of processing commands, compares the computed optical image signature with the pre-determined optical image signature and generates a third flag. Typically, the third flag is either set (true or “logical 1”) or reset (false or “logical 0”) based on the comparison performed by the sixth comparator. The second authentication module, under the second set of processing commands, facilitates a second level authentication for the product when the first the second flag and the third flag are true.

Further, in accordance with the present disclosure, the server includes a product information module. The product information module transmits the pre-stored product details associated with the authenticated tag to the at least one mobile device.

Furthermore, in accordance with the present disclosure, the mobile device includes a first logger module. The first logger module stores a log of the first level authentication.

In accordance with the present disclosure, the server includes a second logger module. The second logger module stores a log of the first level authentication and the second level authentication.

In accordance with the present disclosure, there is provided a method for authenticating product having at least one non-replicable security tag using at least one mobile device and a server.

In accordance with the present disclosure, the variable image pattern is unique per tag.

### BRIEF DESCRIPTION OF THE ACCOMPANYING DRAWING

A system for product authentication of the present disclosure will now be described with the help of the accompanying drawing, in which:

FIG. 1 illustrates a schematic block diagram of a system for product authentication, in accordance with an embodiment of the present disclosure;

FIG. 2a illustrates a schematic view of a background print layer of a non-replicable security tag, in accordance with one embodiment;

FIG. 2b illustrates a schematic view of a foreground print layer of the non-replicable security tag, in accordance with one embodiment;

FIG. 2c illustrates a schematic view of the non-replicable security tag of the present disclosure, in accordance with one embodiment;

FIG. 3 illustrates a sectional view of the non-replicable security tag of FIG. 2c accordance with one embodiment of the present disclosure; and

FIGS. 4A, 4B, 4C, 4D and 4E illustrate flow diagrams representing steps involved during authentication/verification of the non-replicable security tag of FIG. 2c in accordance with one embodiment of the present disclosure.

LIST OF REFERENCE NUMERALS

| Reference numeral | References |
|---|---|
| 100 | System |
| 10 | non-replicable security tag |
| 12 | substrate |
| 14 | background print layer |
| 16 | foreground print layer |
| 18 | tag identifier |
| 20 | variable image pattern |
| 30 | mobile device |
| 32 | first memory |
| 34 | first processor |
| 36 | Camera |
| 38 | Extractor |
| 40 | image processing module |
| 42 | decoder |
| 44 | first comparator |
| 46 | first verification module |
| 48 | spatial color gradient determination module |
| 50 | spatial coefficients determination module |
| 52 | spatial consistency determination module |
| 54 | second comparator |
| 56 | second verification module |
| 58 | tag verification code determination module |
| 60 | an association computation module |
| 62 | third comparator |
| 64 | third verification module |
| 66 | first authentication module |
| 68 | first logger module |
| 70 | server |
| 71 | database |
| 72 | second memory |
| 74 | second processor |
| 76 | transceiver module |
| 78 | a fourth comparator |
| 80 | fourth verification module |
| 82 | digital signature computation module |
| 84 | fifth comparator |
| 86 | fifth verification module |
| 88 | Optical signature computation module |
| 90 | sixth comparator |
| 92 | sixth verification module |
| 94 | second authentication module |
| 96 | product information module |
| 98 | second logger module |
| 102 | first protective layer |
| 104 | second protective layer |
| 106 | Report generation module |

### DETAILED DESCRIPTION

Counterfeiting of products is a menace and use of counterfeited products such as medicinal and pharmaceutical products can prove to be fatal. Attempts have been made to distinguish genuine products from the counterfeits. Such attempts include using holograms, barcodes, and taggants, and frequent change of pack design. However, there is still a need for an anti-counterfeiting measure which is inexpensive and effective, and which does not require use of custom or proprietary devices for identifying counterfeit products from the genuine products. Additionally, there is a need for an anti-counterfeiting measure which is user friendly and does not require consumers to have high technical skills to identify the counterfeit products.

Apart from counterfeiting, there is also a need in the business for tracking movement of a product from the manufacturing end to its point of sale to end customers or consumers. Further, there is also a need in business for authenticating a genuine product and its attributes to the trader/end customer.

To limit the aforementioned drawbacks, the present disclosure describes an anti-counterfeiting technique by envisaging a tag.

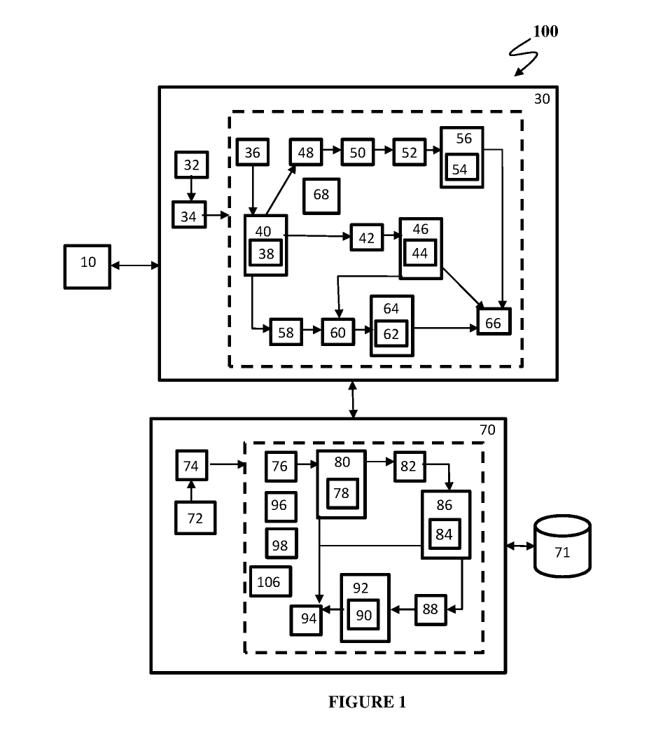

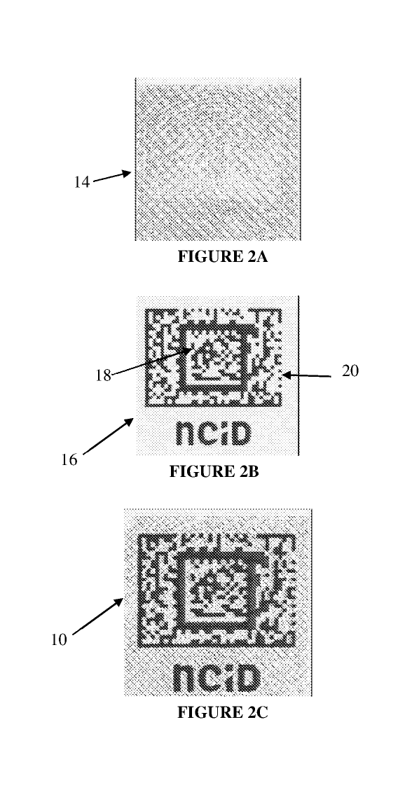

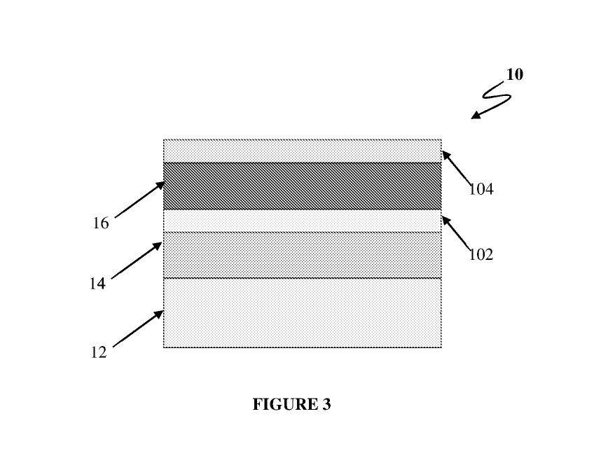

Referring to the accompanying drawing, FIG. 1 illustrates a schematic block diagram of a system for product authentication, in accordance with an embodiment of the present disclosure. FIG. 2a illustrates a schematic view of a background print layer of the non-replicable security tag, FIG. 2b illustrates a schematic view of a foreground print layer of the non-replicable security tag, and the FIG. 2c illustrates a schematic view of a non-replicable security tag, in accordance with one embodiment. FIG. 3 illustrates a sectional view of the non-replicable security tag of FIG. 2c accordance with one embodiment of the present disclosure.

The non-replicable security tag (10) (herein after referred as tag) is a physical tag having a unique security identifier(s). The tag (10) is made of a substrate (12) and a print on the substrate (12).

The substrate (12) can be self-adhesive and tamper-evident. In one embodiment, the substrate (12) has a single layer. In another embodiment, the substrate (12) is multi-layer. In yet another embodiment, the substrate (12) is made of materials selected from the group consisting of papers, polymers, metals, fabrics and any combinations thereof. The substrate (12) can be integral with a product/package or it can be fixed to the product/package. Typically, in a preferred embodiment, the thickness of the substrate (12) ranges from 10 to 150 microns, in case the substrate (12) is fixed to the product/package. A particular embodiment may require a thicker substrate. Typically, a pressure sensitive adhesive is used to fix the substrate (12) to the product/package. In an embodiment, the adhesives are selected from the group consisting of acrylic, vinyl, epoxy, polyurethane based, tamper proof heat curable, UV curable pressure sensitive and the like. The substrate (12) can be common for all the products/packages and can be of any geometrical and/or non-geometrical shape. The substrate (12) is peel able from a strip or an automatic/manual applicator can be used to fix the substrate (12) to the product/package.

The print provided on the substrate (12) contains a background print layer (14) and a foreground print layer (16). In one embodiment, the print is provided by using different printing techniques selected from the group of techniques including thermal, thermal inkjet, inkjet, flexography, variable digital printing, lithography, offset, gravure, rotogravure, screen printing and the like. The print on the tag (10) is multi-pass. The background print layer (14) can be applied on the substrate (12) by one or more passes by using aforementioned printing techniques. The foreground print (16) is printed on the background print layer (14) by variable digital printing techniques. In one embodiment, a first protective layer (102) is provided above the background print layer (14) and a second protective layer (104) is provided above the foreground print layer (16). These protective layers (102) and (104) are selected from a group consisting of acrylic, polyurethane, vinyl, heat curable, UV curable, lacquers or varnish with pigments, and any combinations thereof.

Typically, characteristics of the background print layer (14) may include about 4 to 10 variable features and the foreground print layer 16 may include about 4 to 20 variable features. Typically, the features in the background print layer (14) include a tag pattern, tag colours, tag inks and the like. Typically, the features in the foreground print layer (16) include a tag identifier, a variable image pattern, tag verification codes and the like. The permutations and combinations between the features of the foreground print layer (16) and the background print layer (16) provide unique identity to the tag (10) and therefore to the product/package to which the tag (10) is applied/fixed. The overlapping of these features provides a unique optical signature to each tag.

The present disclosure envisages a system (100) for product authentication using at least one mobile device (30) and a server (70). At least one non-replicable security tag (10) is affixed to the product. In a given batch of products, at least one tag 10 is affixed to each of the product. The tag (10) includes a substrate (12), a background print layer (14) and a foreground print layer (16). The background print layer (14) is printed on an operative top surface of the substrate (12). The background print layer (14) is defining background print features. The foreground print layer (16) is printed on the background print layer (14). The foreground print layer (16) includes at least one tag identifier (18), at least one variable image pattern (20), and encoded security data is embedded in the variable image pattern (20). In an embodiment, the variable image pattern (20) is generated using the tag identifier as one of the parameters. The variable image pattern (20) is unique for each tag. In another embodiment, the tag identifier is selected from the group consisting of 2D datamatrix bar code, and QR code.

In an embodiment, the mobile device (30) includes a first memory (32), a first processor (34), a camera (36), an image processing module (40), a decoder (42), a first verification module (46), a spatial color gradient determination module (48), a spatial coefficients determination module (50), a spatial consistency determination module (52), a second verification module (56), a tag verification code determination module (58), an association computation module (60), a third verification module (64), and a first authentication module (66). Typically, the second verification module is a consistency checking module.

The first memory (32) stores a first set of predetermined rules, and a predefined first security data pattern, a pre-determined consistency factor, and a predetermined association factor for each tag.

The first processor (34) is cooperating with the first memory (32). The first processor (34) receives the first set of predetermined rules and further generates a first set of processing commands.

The camera (36), under the first set of processing commands, scans the tag 10 and generates an optical image.

The image processing module (40) includes an extractor (38). Typically, the image processing module (40) is a digital signal processing unit. The extractor (38), under the first set of processing commands, processes the optical image and extracts the tag identifier, the variable image pattern (20) and the background print features from the optical image.

The decoder (42), under the first set of processing commands, decodes the encoded security data present in the variable image pattern (20) and obtains decoded security data.

The first verification module (46) includes a first comparator (44). The first comparator 44, under the first set of processing commands, compares the decoded security data with the predefined first security data pattern, obtains a verified variable image pattern and generates a variable image pattern flag.

The spatial color gradient determination module (48), under the first set of processing commands, determines a spatial color gradient using the background features such as tag pattern, tag colors and tag ink. Typically, the spatial color gradient is one of the image characteristics. In an embodiment, the spatial color gradient determination module (48) is a digital signal processing unit.

The spatial coefficients determination module (50), under the first set of processing commands, determines spatial coefficients based on the spatial color gradient.

The spatial consistency determination module (52), under the first set of processing commands, determines a consistency factor of the spatial coefficients.

The second verification module (56) includes a second comparator (54). The second comparator (54), under the first set of processing commands, compares the determined consistency factor with the pre-determined consistency factor and generates a consistency flag. Typically, the consistency flag is either set (true or “logical 1”) or reset (false or “logical 0”) based on the comparison performed by the second comparator (54).

The tag verification code determination module (58), under the first set of processing commands, determines a tag verification code using the tag identifier and the variable image pattern.

The association computation module (60), under the first set of processing commands, computes an association factor between the verified variable image pattern and the tag verification code. The third verification module (64) includes a third comparator (62). The third comparator (62), under the first set of processing commands, compares the computed association factor with the predetermined association factor to obtain an association flag. Typically, the association flag is either set (true or “logical 1”) or reset (false or “logical 0”) based on the comparison performed by the third comparator (62).

The first authentication module (66), under the first set of processing commands, facilitates a first level authentication of the product when the variable image pattern flag, the consistency flag and the association flag are true.

The server (70) is coupled to the at least one mobile device (30). The mobile device (30) communicates with the server using wired/wireless communication network. The server (70) includes a second memory (72), a second processor (74), a transceiver module (76), a fourth verification module (80), a digital signature computation module (82), a fifth verification module (86), an optical signature computation module (88), a sixth verification module (92), and a second authentication module (94).

The second memory (72) stores a second set of predetermined rules, and predetermined second security data pattern.

The database (71) stores a pre-determined tag identifier, a pre-determined digital signature, and a pre-determined optical image signature.

The second processor (74) communicates with the second memory (72). The second processor (74) receives the second set of predetermined rules and generates a second set of processing commands.

The transceiver module (76), under the second set of processing commands, receives the optical image, the tag identifier (18), the decoded security data obtained from the variable image pattern (20) and the background print features.

The fourth verification module (80) includes a fourth comparator (78). The fourth comparator (78), under the second set of processing commands, compares the tag identifier with the pre-determined tag identifier and obtains a verified tag identifier and generates a first flag.

The digital signature computation module (82), under the second set of processing commands, computes a digital signature from the verified tag identifier and the variable image pattern using the predetermined second security data pattern.

The fifth verification module (86) includes a fifth comparator (84). The fifth comparator (84), under the second set of processing commands, cooperates with the database (71) and compares the digital signature with the pre-determined digital signature and generates a second flag. Typically, the second flag is either set (true or “logical 1”) or reset (false or “logical 0”) based on the comparison performed by the fifth comparator.

The optical signature computation module (88), under the second set of processing commands, computes an optical image signature based on the tag identifier, the variable image pattern, the background print features and the optical image.

The sixth verification module (92) includes a sixth comparator (90). The sixth comparator (90), under the second set of processing commands, compares the computed optical image signature with the pre-determined optical image signature and generates a third flag. Typically, the third flag is either set (true or “logical 1”) or reset (false or “logical 0”) based on the comparison performed by the sixth comparator (90).

The second authentication module (94), under the second set of processing commands, facilitates a second level authentication for the product when the first flag, second flag and the third flag are true.

In an embodiment, the server (70) includes a product information module (96). The product information module (96) transmits the pre-stored product details associated with the authenticated tag (10) to the at least one mobile device (30).

In an embodiment, the server (100) includes a second logger module (98). The second logger module (98) stores a log of the first level and second level authentication.

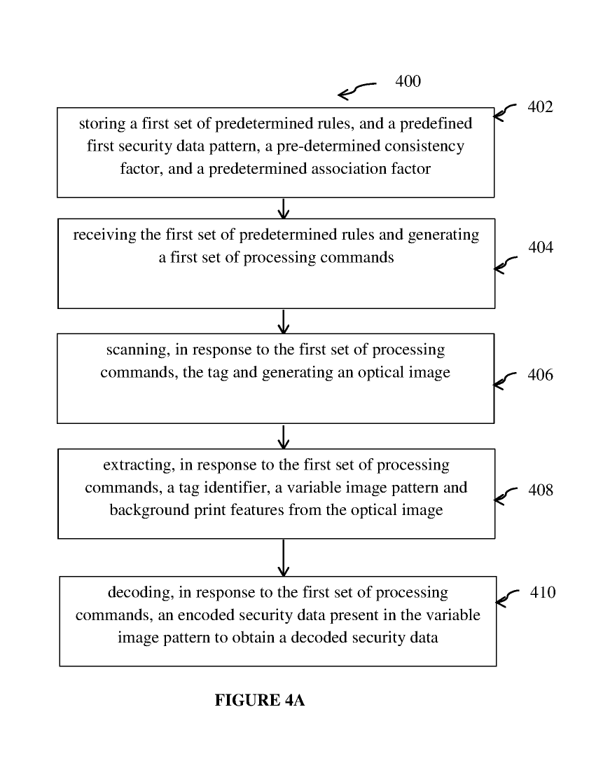

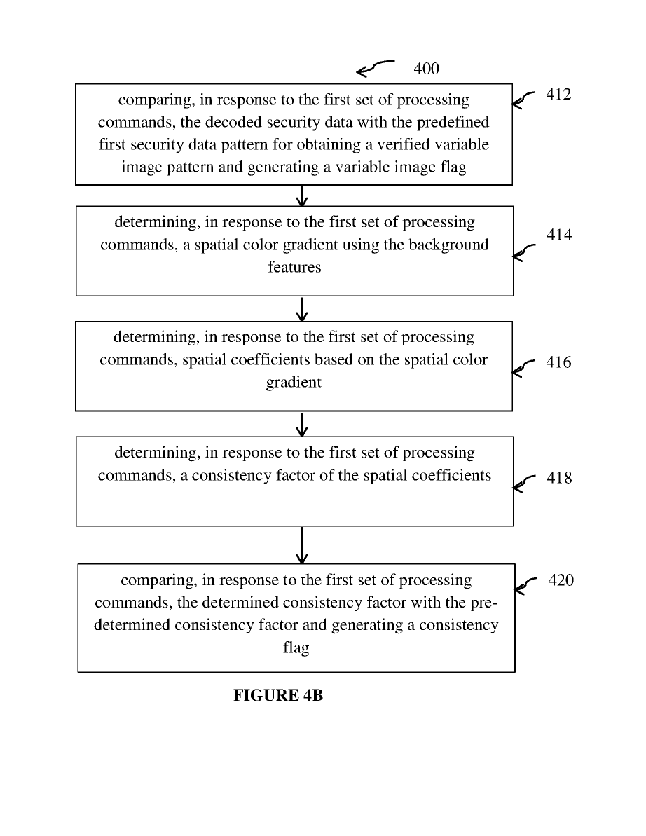

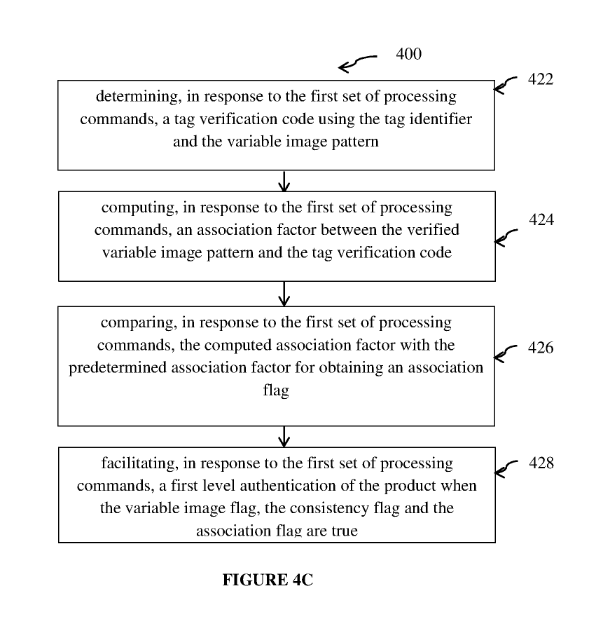

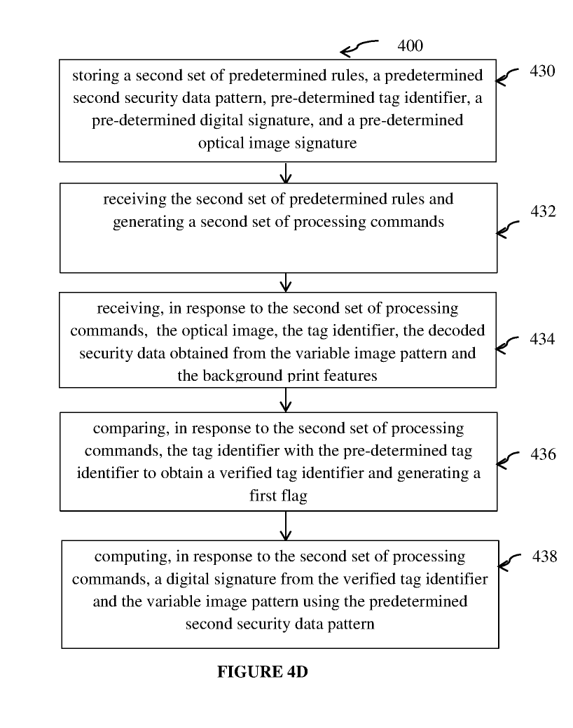

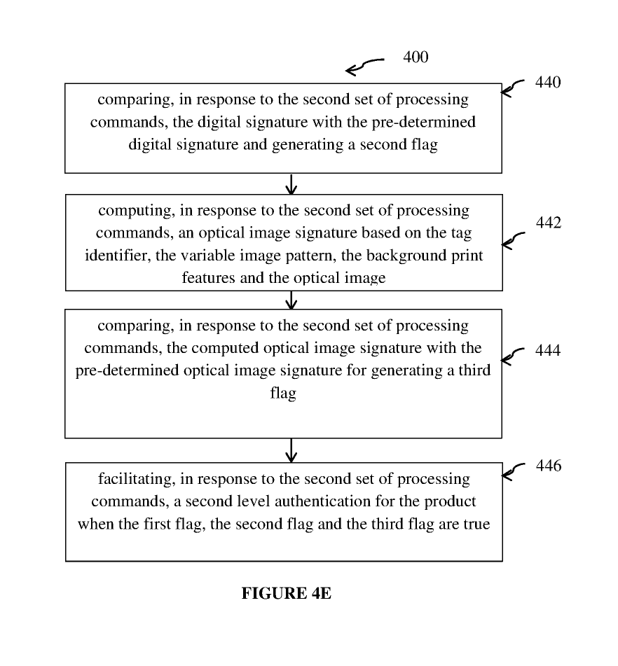

The present disclosure also envisages a method for authenticating product having at least one non-replicable security tag using at least one mobile device. FIGS. 4A, 4B, 4C, 4D, and 4E illustrate a flowchart depicting the method for authenticating product having at least one non-replicable security tag using at least one mobile device and the server. The method 400 may be described in the general context of computer executable instructions. The method 400 may be implemented in any suitable hardware, software, firmware, or any combination thereof.

At block 402, the method 400 includes the step of storing a first set of predetermined rules, and a predefined first security data pattern, a pre-determined consistency factor, and a predetermined association factor. In an embodiment, the first memory (32) is configured to store the first set of predetermined rules, the predefined first security data pattern, the pre-determined consistency factor, and the predetermined association factor for each tag.

At block 404, the method 400 includes the step of receiving the first set of predetermined rules and generating a first set of processing commands. In an embodiment, the first processor (34) is configured to receive the first set of predetermined rules to generate the first set of processing commands.

At block 406, the method 400 includes the step of scanning, in response to the first set of processing commands, the tag and generating an optical image. In an embodiment, the camera (36) is configured to scan the tag to generate an optical image.

At block 408, the method 400 includes the step of extracting, in response to the first set of processing commands, a tag identifier, a variable image pattern and background print features from the optical image. In an embodiment, the image processing module (40) having an extractor (38), is configured to process the optical image and extract the tag identifier (18), the variable image pattern (20) and the background print features from the optical image.

At block 410, the method 400 includes the step of decoding, in response to the first set of processing commands, an encoded security data present in the variable image pattern to obtain a decoded security data. In an embodiment, the decoder (42) is configured to decode the encoded security data present in the variable image pattern (20) to obtain decoded security data.

At block 412, the method 400 includes the step of comparing, in response to the first set of processing commands, the decoded security data with the predefined first security data pattern for obtaining a verified variable image pattern and generating a variable image pattern flag. In an embodiment, the first verification module (46) having the first comparator (44), is configured to compare the decoded security data with the predefined first security data pattern for obtaining the verified variable image pattern and generating a variable image pattern flag.

At block 414, the method 400 includes the step of determining, in response to the first set of processing commands, a spatial color gradient using the background features. In an embodiment, the spatial color gradient determination module (48), is configured to determine a spatial color gradient using the background features.

At block 416, the method 400 includes the step of determining, in response to the first set of processing commands, spatial coefficients based on the spatial color gradient. In an embodiment, the spatial coefficients determination module (50), is configured to determine spatial coefficients based on the spatial color gradient.

At block 418, the method 400 includes the step of determining, in response to the first set of processing commands, a consistency factor of the spatial coefficients. In an embodiment, the spatial consistency determination module (52), is configured to determine the consistency factor of the spatial coefficients.

At block 420, the method 400 includes the step of comparing, in response to the first set of processing commands, the determined consistency factor with the pre-determined consistency factor and generating a consistency flag. In an embodiment, the second verification module (56) having a second comparator (54), is configured to compare the determined consistency factor with the pre-determined consistency factor to generate the consistency flag.

At block 422, the method 400 includes the step of determining, in response to the first set of processing commands, a tag verification code using the tag identifier and the variable image pattern. In an embodiment, the tag verification code determination module (58), is configured to determine the tag verification code using the tag identifier (18) and the variable image pattern (20).

At block 424, the method 400 includes the step of computing, in response to the first set of processing commands, an association factor between the verified variable image pattern and the tag verification code. In an embodiment, the association computation module (60), is configured to compute the association factor between the verified variable image pattern and the tag verification code.

At block 426, the method 400 includes the step of comparing, in response to the first set of processing commands, the computed association factor with the predetermined association factor for obtaining an association flag. In an embodiment, the third verification module (64) having a third comparator (62), is configured to compare the computed association factor with the predetermined association factor to obtain the association flag.

At block 428, the method 400 includes the step of facilitating, in response to the first set of processing commands, a first level authentication of the product when the variable image pattern flag, the consistency flag and the association flag are true. In an embodiment, the first authentication module (66), is configured to facilitate the first level authentication of the tag (10) affixed to the product when the variable image pattern flag, the consistency flag and the association flag are true.

At block 430, the method 400 includes the step of storing a second set of predetermined rules, a pre-determined tag identifier, a pre-determined digital signature, and a pre-determined optical image signature. In an embodiment, the second memory (72) is configured to store the second set of predetermined rules and a predetermined second security data pattern. The database (71) is configured to store the pre-determined tag identifier, the pre-determined digital signature, and the pre-determined optical image signature.

At block 432, the method 400 includes the step of receiving the second set of predetermined rules and generating a second set of processing commands. In an embodiment, the second processor (74) is configured to cooperate with the second memory (72) to receive the second set of predetermined rules and is further configured to generate the second set of processing commands.

At block 434, the method 400 includes the step of receiving, in response to the second set of processing commands, the optical image, the tag identifier, the decoded security data obtained from the variable image pattern and the background print features. In an embodiment, the transceiver module (76) is configured to receive the optical image, the tag identifier, decoded security data obtained from the variable image pattern (20) and the background print features.

At block 436, the method 400 includes the step of comparing, in response to the second set of processing commands, the tag identifier with the pre-determined tag identifier for obtaining a verified tag identifier and generating a first flag. In an embodiment, the fourth verification module (80) having a fourth comparator (78), is configured to compare the tag identifier (18) with the pre-determined tag identifier to obtain the verified tag identifier and generate a first flag.

At block 438, the method 400 includes the step of computing, in response to the second set of processing commands, a digital signature from the verified tag identifier and the variable image pattern. In an embodiment, the digital signature computation module (82), is configured to compute a digital signature from the verified tag identifier and the variable image pattern (20) using said predetermined second security data pattern.

At block 440, the method 400 includes the step of comparing, in response to the second set of processing commands, the digital signature with the pre-determined digital signature and generating a second flag. In an embodiment, the fifth verification module (86) having a fifth comparator (84), is configured to compare the digital signature with the pre-determined digital signature to generate the second flag.

At block 442, the method 400 includes the step of computing, in response to the second set of processing commands, an optical image signature based on the tag identifier, the variable image pattern, the background print features, and the optical image. In an embodiment, the optical signature computation module (88), is configured to compute the optical image signature based on the tag identifier, the variable image pattern (20), the background print features and the optical image.

At block 444, the method 400 includes the step of comparing, in response to the second set of processing commands, the computed optical image signature with the pre-determined optical image signature for generating a third flag. In an embodiment, the sixth verification module (92) having a sixth comparator (90), is configured to compare the computed optical image signature with the pre-determined optical image signature to generate the third flag.

At block 446, the method 400 includes the step of facilitating, in response to the second set of processing commands, a second level authentication for the product when the first flag, the second flag and third flag are true. In an embodiment, the second authentication module (94), is configured to facilitate the second level authentication of the tag (10) affixed to the product when the first flag, the second flag and third flag are true.

In order to authenticate the tag (10), an image of the tag (10) is captured. In one embodiment, any authorized camera-enabled handheld device (i.e. at least one mobile device 30) including a smartphone, laptop, PDA, tablet, iPhone etc., acts as a reader to scan the tag (10), captures an image of the tag (10) and authenticates the tag (10) with and/or without the Internet/network connectivity. As the features of the background print layer (14) and the foreground print layer (16) provides a unique optical image signature for every tag (10), a reader/handheld device cannot read the tag (10) unless format of the encoded data is known to the reader/handheld device. This prevents counterfeiting of the tag (10) by un-authorized reader/handheld devices. Even if the tag (10) is photocopied, the unique encoded/derived data, (like image characteristics) of the tag (10) cannot be duplicated thereby making the tag (10) non-replicable. Additionally, as the unique data is random, it is difficult as well as expensive to manufacture/produce copies of the tags of the present disclosure thereby making the tag (10) non-clone-able.

The use of proprietary print signature on the substrate (12) helps in generating image information for additional verifications. The combination of the substrate (12) with the proprietary print features of the background print layer (14) and the foreground print layer (16) enable derivation of image characteristics and the optical image signature. The image characteristics (for example variable image pattern, encoded security data, spatial color gradient etc.) are verifiable locally by the authorized handheld device to provide a first level of authentication. The verification of the optical image signature is done at a secured server (70) thereby providing a second level authentication. The verification of the image information (the image characteristics and the optical image signature) can be done only by using authorized handheld devices and pre-determined techniques, which makes the tag (10) non-photo-copyable and non-printable. This verification of the image information (the image characteristics and the optical image signature) and it's relation with the digital information (the tag verification code(s) and the digital signature) makes the tag non-replicable and non-cloneable.

In an embodiment, to authenticate the tag (10), the tag (10) is first scanned using an authorized camera-enabled handheld device by a user, which captures an optical image of the tag (10). This optical image consists of the variable image pattern. The structure of the variable image pattern then is verified. If the verification fails, a tag authentication fail message is sent to the handheld device and these details are stored in a device logger module (i.e. the first logger module 68) present in the handheld device (30). If the verification is successful, the image characteristics in the tag's optical image are verified. If the verification fails, a tag authentication fail message is sent to the handheld device (30) and these details are stored in the device logger module (i.e. the first logger module 68). If the verification is successful, the variable image pattern and the tag verification codes are re-computed and checked to validate the association between the tag verification codes and the variable image pattern. If the validation fails, a tag authentication fail message is sent to the handheld device and these details are stored in the device logger module (i.e. the first logger module 68). If the validation is successful, a check is performed to detect if the Internet is available for a second level authentication. If the Internet is unavailable, a first level authentication success message is sent to the handheld device (30) along with a message recommending the user to enable the Internet for the second level authentication. This information is stored in the device logger module (i.e. the first logger module 68) for sending and syncing the logs at the server in future whenever the network/internet is available. If the Internet is available, the authentication log present in the device logger module (i.e. the first logger module 68) is sent to the logger module (i.e. the second logger module 98) present in the server (70). The authentication log which is sent to the server (70) includes all the past logs/records stored in the device logger module (i.e. the first logger module 68) that have not been updated in the server (70). If the authentication log is not available on the handheld device, tag data and optical image is sent to the server. Validity of the unique tag identifier is checked by the server (70). If the tag identifier is not valid, an authentication fail message is sent to the handheld device (30) and stored in the logger module (98). If the tag identifier is valid, reference data associated with the tag identifier is fetched, a digital signature is computed from the tag (10) variable image pattern and, the digital signature is compared with the reference digital signature (pre-determined digital signature). If the signatures do not match, an authentication fail message is sent to the handheld device (30) and stored in the logger module (the second logger module 98). If the signatures match, an optical image signature is computed from the optical image and is compared with the reference optical image signature (pre-determined optical image signature). If the optical image signature does not match the reference optical image signature, an authentication fail message is sent to the handheld device and stored in the logger module (the second logger module 98). If the optical image signature matches the reference optical image signature, product information associated with the tag is fetched from the product information module. If the product information is not available then a tag authentication success message is sent to the handheld device and saved in the logger module (the second logger module 98) for future reference. If the product information is available then a tag authentication success message and the product information is sent to the mobile device and saved in the logger module (the second logger module 98) for future reference.

In an embodiment, the tag can be printed directly online on the product and there is no need of any label to be applied on the product. In an embodiment, the first logger module stores a log of the first level authentication and the second logger module 98 stores a log of the first level and second level authentication.

In another embodiment, the data from the first logger module is synchronized with the data in the second logger modules upon availability of the internet and/or network connectivity.

In yet another embodiment, the data from the second logger is analyzed in corroboration with the tracking data to generate insights related to a plurality of authentication events in context of time, location and mobile device.

In an embodiment, the server includes a report generation module (106). The report generation module (106) is configured to generate an analytical report based on the input from the first logger module (68) and the second logger module (98).

### Technical Advancements

The technical advancements of the location information system envisaged by the present disclosure include the realization of:
a system for product authentication which is robust, inexpensive and effective.
a system for product authentication which uses mobile identifying counterfeit products from genuine products.
a system for product authentication which does not require the consumers to have high technical skills for identifying counterfeits and which is user-friendly.
a system for product authentication which can authenticate the product without using the internet.

The disclosure has been described with reference to the accompanying embodiments which do not limit the scope and ambit of the disclosure. The description provided is purely by way of example and illustration.

The embodiments herein above and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein.

Accordingly, the examples should not be construed as limiting the scope of the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification, specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A system (100) for product authentication, said system (100) comprising:
at least one non-replicable security tag (10) affixed to a product, the tag (10) comprising:
a substrate (12);
a background print layer (14) printed on an operative top surface of the substrate, said background print layer (14) defining background print features; and
a foreground print layer (16) printed on the background print layer (14), said foreground print layer (16) defining:
at least one tag identifier (18);
at least one variable image pattern (20); and
encoded security data embedded in said variable image pattern (20);
at least one mobile (30) device comprising:
a first memory (32) configured to store a first set of predetermined rules, and a predefined first security data pattern, a pre-determined consistency factor, and a predetermined association factor;
a first processor (34) configured to cooperate with the first memory (32) to receive the first set of predetermined rules and further configured to generate a first set of processing commands;
a camera (36), under the first set of processing commands, configured to scan said tag (10) and generate an optical image;
an image processing module (40) having an extractor (38), under the first set of processing commands, configured to process said optical image and extract the tag identifier (18), the variable image pattern (20) and the background print features from said optical image;
a decoder (42), under the first set of processing commands, configured to decode the encoded security data present in said variable image pattern (20) to obtain decoded security data;
a first verification module (46) having a first comparator (44), under the first set of processing commands, configured to compare the decoded security data with the predefined first security data pattern to obtain a verified variable image pattern and generate a variable image pattern flag;
a spatial color gradient determination module (48), under the first set of processing commands, configured to determine a spatial color gradient using the background features;
a spatial coefficients determination module (50), under the first set of processing commands, configured to determine spatial coefficients based on said spatial color gradient;
a spatial consistency determination module (52), under the first set of processing commands, configured to determine a consistency factor of said spatial coefficients;
a second verification module (56) having a second comparator (54), under the first set of processing commands, configured to compare the determined consistency factor with the pre-determined consistency factor to generate a consistency flag;
a tag verification code determination module (58), under the first set of processing commands, configured to determine a tag verification code using the tag identifier (18) and the variable image pattern (20);
an association computation module (60), under the first set of processing commands, configured to compute an association factor between the verified variable image pattern and the tag verification code;
a third verification module (64) having a third comparator (62), under the first set of processing commands, configured to compare the computed association factor with the predetermined association factor to obtain an association flag; and
a first authentication module (66), under the first set of processing commands, configured to facilitate a first level authentication of the tag (10) affixed to the product when said variable image pattern flag, said consistency flag and said association flag are true.

2. The system as claimed in claim 1, wherein said system includes a server (70) coupled to said at least one mobile device (30), said server (70) comprising:
a second memory (72) configured to store a second set of predetermined rules, and a predetermined second security data pattern;
a database (71) configured to store a pre-determined tag identifier, a pre-determined digital signature, and a pre-determined optical image signature;
a second processor (74) configured to cooperate with the second memory (72) to receive the second set of predetermined rules and further configured to generate a second set of processing commands;
a transceiver module (76), under the second set of processing commands, configured to receive said optical image, said tag identifier, said decoded security data obtained from said variable image pattern (20) and said background print features;
a fourth verification module (80) having a fourth comparator (78), under the second set of processing commands, configured to compare the tag identifier (18) with said pre-determined tag identifier to obtain a verified tag identifier and generate a first flag;
a digital signature computation module (82), under the second set of processing commands, configured to compute a digital signature from said verified tag identifier and said variable image pattern (20) using said predetermined second security data pattern;
a fifth verification module (86) having a fifth comparator (84), under the second set of processing commands, configured to cooperate with said database (71) and further configured to compare the digital signature with the pre-determined digital signature to generate a second flag;
an optical signature computation module (88), under the second set of processing commands, configured to compute an optical image signature based on said tag identifier, said variable image pattern (20), said background print features and said optical image;
a sixth verification module (92) having a sixth comparator (90), under the second set of processing commands, configured to cooperate with said database (71) and further configured to compare said computed optical image signature with the pre-determined optical image signature to generate a third flag; and
a second authentication module (94), under the second set of processing commands, configured to facilitate a second level authentication of the tag (10) affixed to the product when said first flag, said second flag and said third flag are true.

3. The system as claimed in claim 2, said server includes a product information module (96) configured to transmit the pre-stored product details associated with the authenticated tag to said mobile device using said transceiver (76).

4. The system as claimed in claim 1, wherein the mobile device includes a first logger module (68) configured to store a log of the first level authentication.

5. The system as claimed in claim 2, wherein the server includes a second logger module (98) configured to store a log of the first level and second level authentication.

6. The system for product authentication as claimed in claim 1, wherein said non-replicable security tag (10) includes a first protective layer (102) disposed on the background print layer (14) and a second protective layer (104) disposed on the foreground print layer (16).

7. The system for product authentication as claimed in claim 1, wherein said variable image pattern is generated using the tag identifier (18) as one of the parameters.

8. The system as claimed in claim 1, wherein said tag identifier (18), which is a unique random number, is selected from the group consisting of 2D datamatrix bar code, and QR code.

9. The system as claimed in claim 1, wherein said variable image pattern is unique per tag.

10. A method for authenticating product having at least one non-replicable security tag using at least one mobile device and a server, said method comprising following steps:
storing a first set of predetermined rules, and a predefined first security data pattern, a pre-determined consistency factor, and a predetermined association factor;
receiving the first set of predetermined rules and generating a first set of processing commands;
scanning, in response to the first set of processing commands, said tag and generating an optical image;
extracting, in response to the first set of processing commands, a tag identifier, a variable image pattern and background print features from said optical image;
decoding, in response to the first set of processing commands, an encoded security data present in said variable image pattern to obtain a decoded security data;
comparing, in response to the first set of processing commands, the decoded security data with the predefined first security data pattern for obtaining a verified variable image pattern and generating a variable image flag;
determining, in response to the first set of processing commands, a spatial color gradient using the background features;
determining, in response to the first set of processing commands, spatial coefficients based on said spatial color gradient;
determining, in response to the first set of processing commands, a consistency factor of said spatial coefficients;
comparing, in response to the first set of processing commands, the determined consistency factor with the pre-determined consistency factor and generating a consistency flag;
determining, in response to the first set of processing commands, a tag verification code using the tag identifier and the variable image pattern;
computing, in response to the first set of processing commands, an association factor between the verified variable image pattern and the tag verification code;
comparing, in response to the first set of processing commands, the computed association factor with the predetermined association factor for obtaining an association flag; and
facilitating, in response to the first set of processing commands, a first level authentication of the product when said variable image flag, said consistency flag and said association flag are true.

11. The method as claimed in claim 10, wherein said method further includes following steps:
storing a second set of predetermined rules, and a predetermined second security data pattern;
storing a pre-determined tag identifier, a pre-determined digital signature, and a pre-determined optical image signature;
receiving the second set of predetermined rules and generating a second set of processing commands;
receiving, in response to the second set of processing commands, said optical image, said tag identifier, said decoded security data obtained from said variable image pattern and said background print features;
comparing, in response to the second set of processing commands, the tag identifier with said pre-determined tag identifier to obtain a verified tag identifier and generating a first flag;
computing, in response to the second set of processing commands, a digital signature from said verified tag identifier and said variable image pattern using said predetermined second security data pattern;
comparing, in response to the second set of processing commands, the digital signature with the pre-determined digital signature and generating a second flag;
computing, in response to the second set of processing commands, an optical image signature based on said tag identifier, said variable image pattern, said background print features and said optical image;
comparing, in response to the second set of processing commands, said computed optical image signature with the pre-determined optical image signature for generating a third flag; and
facilitating, in response to the second set of processing commands, a second level authentication for the product when said first flag, said second flag and said third flag are true.
